(19) United States
(12) Patent Application Publication
(10) Pub. No.: US 2023/0377110 A1
(43) Pub. Date: Nov. 23, 2023

(54) METHOD AND DEVICE FOR PROCESSING IMAGE, STORAGE MEDIUM, AND COMPUTING DEVICE

(71) Applicant: Aocheng Intelligence Technology (USA) Inc., Cary, NC (US)

(72) Inventors: Jianyue PAN, Beijing (CN); Liwen ZHANG, Beijing (CN); Deyun REN, Beijing (CN); Jie LI, Beijing (CN)

(73) Assignee: Aocheng Intelligence Technology (USA) Inc., Cary, NC (US)

(21) Appl. No.: 18/317,745

(22) Filed: May 15, 2023

(30) Foreign Application Priority Data
May 19, 2022 (CN) 202210542955.4

(51) Int. Cl. G06T 5/50; G06T 7/00; G06T 5/20; G06V 10/56; G06V 10/60

(52) U.S. Cl. CPC G06T 5/50; G06T 7/0002; G06T 5/20; G06V 10/56; G06V 10/60; G06T 2207/10024; G06T 2207/20221; G06V 2201/09

(57) ABSTRACT

Disclosed are a method and a device for processing an image, a storage medium, and a computing device. The method includes: acquiring a to-be-processed image, where the to-be-processed image at least includes a background and a pattern; converting the to-be-processed image into a first color space to obtain a first image component of the to-be-processed image in a first channel; converting the to-be-processed image into a second color space to obtain a second image component of the to-be-processed image in a second channel; and performing image fusion based on the first image component and the second image component to obtain a target image, where the pattern is similar to the background in terms of intensity in the target image.

### CROSS-REFERENCE TO RELATED APPLICATIONS

This application claims priority to Chinese Patent Application No. 202210542955.4, filed on May 19, 2022, the content of which is incorporated herein by reference in its entirety.

### TECHNICAL FIELD

Embodiments of the present application relate to the field of image processing, and in particular to a method and a device for processing an image, a storage medium, and a computing device.

### BACKGROUND

This part is intended to provide a background or context for embodiments of the present application that are recited in the claims. The description herein is not admitted to be prior art by inclusion in this part.

In the prior art, the influence of printed characters is generally eliminated in two manners before defect detection is performed on the appearance of a printed capsule. In the first manner, all possible positions of the printed characters are recorded and no check is taken on these positions. The first manner is relatively simple and crude, resulting in a risk of missing defects. In the second manner, outlines of the characters are accurately obtained with the optical character recognition (OCR) technology, and then the interference caused by characters is filtered out. However, the OCR technology is poor in real-time performance, and thus it is difficult to meet the high-speed production requirements of capsules.

### SUMMARY

In this context, it is desired to provide a method and a device for processing an image, a storage medium, and a computing device according to embodiments of the present application, so as to quickly and efficiently reduce a difference between a pattern on a capsule body in the image and the capsule body, thereby reducing the influence of the pattern on the appearance detection of the capsule.

A method of processing an image is provided according to a first aspect of the embodiments of the present application. The method includes: acquiring a to-be-processed image, where the to-be-processed image at least includes a background and a pattern; converting the to-be-processed image into a first color space to obtain a first image component of the to-be-processed image in a first channel, wherein the first channel describes at least hue information of the image, and the pattern and the background in the first image component behave differently than in a second image component in terms of intensity; converting the to-be-processed image into a second color space to obtain the second image component of the to-be-processed image in a second channel, wherein the second channel describes at least brightness information of the image, and a contrast of intensity between the pattern and the background in the second image component is similar to a contrast of intensity between the pattern and the background in the to-be-processed image; and performing image fusion based on the first image component and the second image component to obtain a target image, wherein the pattern is similar to the background in terms of the intensity in the target image.

In an embodiment of the present application, the acquiring a to-be-processed image includes: acquiring an original image, and performing enhancement processing on the original image to obtain the to-be-processed image.

In an embodiment of the present application, the performing image fusion based on the first image component and the second image component to obtain a target image includes: performing the image fusion based on the first image component and the second image component to obtain a candidate target image; and performing preset filtering processing on the candidate target image to obtain the target image.

In an embodiment of the present application, the converting the to-be-processed image into a second color space includes: converting the to-be-processed image into the first color space to obtain a first image; and converting the first image into the second color space. In an embodiment of the present application, the first color space is an RGB color space or an XYZ color space, and the second color space is a Lab color space.

In an embodiment of the present application, the first channel is a G channel in a case that the first color space is an RGB color space, and the second channel is an L channel in a case that the second color space is a Lab color space.

In an embodiment of the present application, the original image is an image of a package, the background is a package body, and the pattern includes at least one of a character, a logo and a graphic.

A device of processing an image is provided according to a second aspect of the embodiments of the present application. The device includes: an acquisition module, a first conversion module, a second conversion module, and a processing module. The acquisition module is configured to acquire a to-be-processed image, where the to-be-processed image at least includes a background and a pattern. The first conversion module is configured to convert the to-be-processed image into a first color space to obtain a first image component of the to-be-processed image in a first channel, wherein the first channel describes at least hue information of the image, and the pattern and the background in the first image component behave differently than in a second image component in terms of intensity. The second conversion module is configured to convert the to-be-processed image into a second color space to obtain the second image component of the to-be-processed image in a second channel, wherein the second channel describes at least brightness information of the image, and a contrast of the intensity between the pattern and the background in the second image component is similar to a contrast of the intensity between the pattern and the background in the to-be-processed image. The processing module is configured to acquire perform image fusion based on the first image component and the second image component to obtain a target image, wherein the pattern is similar to the background in terms of the intensity in the target image.

A computer-readable storage medium is provided according to a third aspect of the embodiments of the present application. The storage medium stores a computer program that, when executed by a processor, implements the method described in the first aspect.

A computing device is provided according to a fourth aspect of the embodiments of the present application. The computing device includes a processor and a storage medium storing program code. The program code, when executed by the processor, implements the method described in the first aspect.

With the method and the device for processing an image, the storage medium, and the computing device according to the embodiments of the present application, the to-be-processed image including the background and the pattern is converted to the first color space and the second color space to acquire the first image component of the to-be-processed image in the first channel and the second image component of the to-be-processed image in the second channel, respectively. The first channel describes at least hue information of the image. The second channel describes at least brightness information of the image. The pattern and the background in the first image component behave differently than in a second image component in terms of intensity. The contrast of the intensity between the pattern and the background in the second image component is similar to a contrast of the intensity between the pattern and the background in the to-be-processed image. Finally, image fusion is performed on the first image component and the second image component to obtain the target image. The pattern is similar to the background in terms of the intensity in the target image. Image components of two different channels of the to-be-processed image in two respective color spaces that meet preset conditions are acquired, and then the two image components are fused in the preset manner, so that the difference between the pattern and the background in the to-be-processed image is reduced, thereby significantly reducing the influence of the pattern on the subsequent defect detection, and bringing a better experience to the user. In addition, because the processing only involves simple conversion between color spaces and simple calculation, the complexity is lower and the efficiency is higher, which can quickly and efficiently reduce the difference between the pattern on the capsule body in the image and the capsule body, and thus is more suitable for capsule appearance detection in real-time.

### BRIEF DESCRIPTION OF THE DRAWINGS

The above and other objects, features and advantages of illustrative embodiments of the present application will become readily understood by reading the following detailed description with reference to the drawings. In the drawings, several embodiments of the present application are shown by way of illustration rather than limitation. In the drawings:

FIG. 1 is a schematic flowchart illustrating a method for processing an image according to an embodiment of the present application;

FIG. 2 is a schematic diagram illustrating an image of a printed capsule according to an embodiment of the present application;

FIG. 3a and FIG. 3b are schematic diagrams illustrating the effect of the image of the printed capsule before and after enhancement processing according to an embodiment of the present application;

FIG. 4a, FIG. 4b and FIG. 4c are schematic diagrams illustrating the image of the printed capsule in three channels of an RGB color space according to an embodiment of the present application;

FIG. 5a, FIG. 5b and FIG. 5c are schematic diagrams illustrating the image of the printed capsule in three channels of a Lab color space according to an embodiment of the present application;

FIG. 6a, FIG. 6b and FIG. 6c are schematic diagrams illustrating the effect of a first image component and a second image component before and after weighted fusion according to an embodiment of the present application;

FIG. 7a and FIG. 7b are schematic diagrams illustrating the effect of the image of the printed capsule before and after Gaussian filtering according to an embodiment of the present application;

FIG. 8a and FIG. 8b are schematic diagrams illustrating the effect of an image of a printed capsule with a defect before and after processing according to an embodiment of the present application;

FIG. 9 is a schematic structural diagram illustrating a device for processing an image according to an embodiment of the present application;

FIG. 10 is a schematic structural diagram illustrating a storage medium for implementing the present application; and

FIG. 11 is a schematic structural diagram illustrating a computing device for implementing the present application.

In the drawings, the same or corresponding reference numerals denote the same or corresponding parts.

### DETAILED DESCRIPTION OF DETAILED DESCRIPTION

The principles and spirit of the present application will be described below with reference to the illustrative embodiments. It should be understood that these embodiments are given only to help those skilled in the art better understand the present application so as to implement the present application, rather than to limit the scope of the present application in any way. Instead, these embodiments are provided so that the present application will be thorough and complete and the scope of the present application can be fully conveyed to those skilled in the art.

Those skilled in the art should understand that the embodiments of the present application may be implemented as a system, a device, an apparatus, a method or a computer program product. Therefore, the present application can be implemented specifically in the form of complete hardware, complete software (including firmware, resident software, microcode, etc.), or a combination of hardware and software.

A method and a device for processing an image, a storage medium, and a computing device are provided according to the embodiments of the present application.

In addition, the number of elements in the drawings is for illustration rather than limitation, and any designation is for distinction only and has no limiting meaning.

The principles and spirit of the present application will be explained in detail below with reference to typical embodiments of the present application.

Illustrative Method

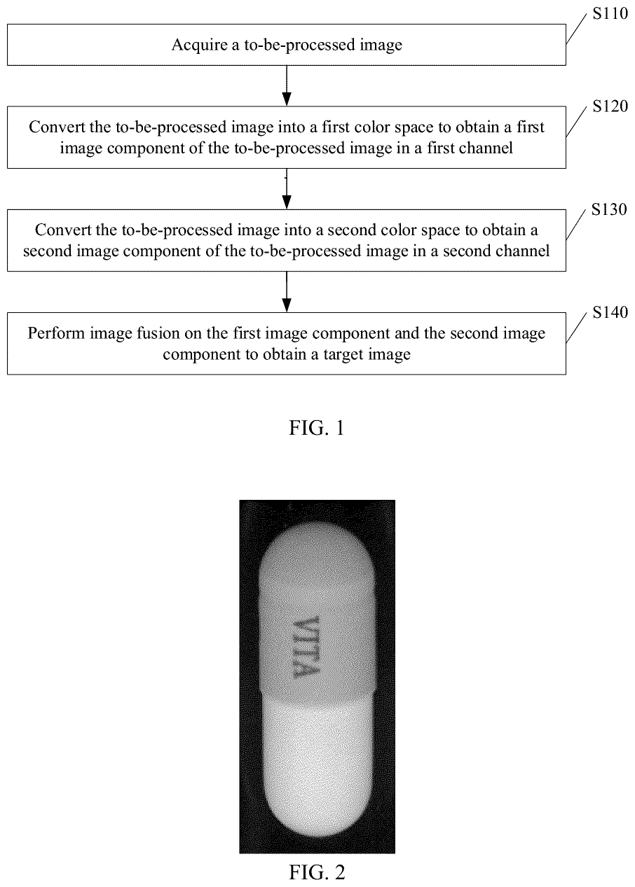

A method for processing an image according to an embodiment of the present application is described below with reference to FIG. 1. The present application is applicable to scenarios of defect detection on printed objects such as capsules. Specifically, the present application involves the image processing before the defect detection, so as to suppress or eliminate the influence of patterns printed on the objects on the defect detection. It should be noted that the above application scenarios are only shown for the purpose of understanding the spirit and principles of the present application, and the implementations of the present application are not limited in this respect. Instead, the embodiments of the present application are applicable to any appropriate scenario.

A method for processing an image is provided according to an embodiment of the present application. The method includes the following steps S110 to S140.

In step S110, a to-be-processed image is acquired.

The to-be-processed image may be an original image captured by an image acquisition device based on an object to be detected for defects. The object may be a capsule, on which a pattern is printed, e.g., a printed capsule, and the to-be-processed image is an image of the printed capsule to be detected for defects. As shown in FIG. 2, the image of the printed capsule includes the object itself to be detected for defects (that is, the capsule body, which is also called the background) and a pattern (that is, characters printed on the surface of the capsule).

It can be understood that although the image of the printed capsule is taken as an example in some embodiments of the present application to describe how to perform the method for processing an image according to the present application, the method for processing an image according to the present application is not limited to processing images of printing capsules. Instead, the method for processing an image according to the present application is also applicable to other pre-processing procedures for defect detection of objects with patterns printed on them, such as images of packages, specifically a package bag or box with patterns printed on it.

It should be noted that the method for processing an image according to the present application is not only suitable for processing images of objects printed with characters. That is, the object to be detected for defects may also be printed with non-textual patterns such as logos and graphics. That is, the pattern printed on the object is not limited to characters. Instead, the pattern printed on the object may also include logos and graphics, or any combination of characters, logos and graphics. Therefore, in an embodiment, the original image is an image of a package, the background is the package body, and the pattern includes at least one of a character, a logo and a graphic.

It is considered that the original image captured by the image acquisition device is easily affected by image acquisition conditions (such as the illumination and the angle, etc.), and thus the original image may be different from the real representation of the object. For example, the captured image of the printed capsule may be dark, and thus the contrast between the character and the capsule body in the image is not as obvious as it actually is. That is, the contrast and detail resolution in the image are low, which may have an adverse effect on the subsequent image processing. In order to eliminate the image distortion caused during the image acquisition, the to-be-processed image is obtained by processing the original image in an example of this embodiment. For example, enhancement processing may be performed on the original image so as to enhance the contrast and detail resolution of the original image to obtain the to-be-processed image.

Since most Complementary Metal Oxide Semiconductor (CMOS) image processing devices obey the power law, that is, the devices for image acquisition, printing and display obey the power law. For example, a cathode ray tube of an image acquisition device has a grayscale-voltage response. The grayscale-voltage response is a power function with an exponent ranging from 1.8 to 2.5. As can be seen from the grayscale-voltage response curve, image displays tend to produce an image that is darker than the real object. In an embodiment, the acquired image may be corrected by a power law (Gamma) transformation. That is, the enhancement processing performed on the original image may be Gamma transformation, so that the to-be-processed image obtained through the enhancement processing is close to a real object in appearance.

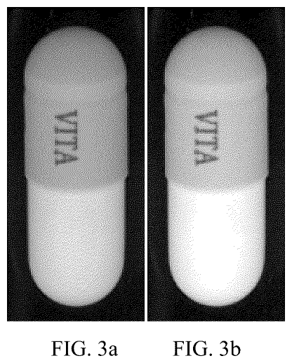

FIG. 3a and FIG. 3b show examples of a group of images of the printed capsule, FIG. 3a shows the original image, and FIG. 3b shows the to-be-processed image obtained from the original image after performing the Gamma transformation. It can be seen that after the Gamma transformation, the contrast and detail resolution of the to-be-processed image are improved.

Some possible specific sources and acquisitions of the to-be-processed image are introduced in the foregoing embodiments. After being acquired, the to-be-processed image is subjected to certain processing so as to eliminate the influence of the pattern in the to-be-processed image on defect detection, such that the to-be-processed image is more suitable for the defect detection.

The inventors have found that it is possible to determine how to accurately detect a defect on a capsule under the influence of the pattern from the perspective of how the human eye distinguishes the defect on the printed capsule. Specifically, it is considered how the human eye distinguishes the difference between a character and a defect. For example, the human eye can clearly distinguish a defect and a character on the capsule even if the human does not recognize the character printed on the capsule. That is, the human eye's ability to distinguish the character and the defect does not rely entirely on its own experiential recognition of the character (i.e., the overall shape or outline), but rather on the appearance of the character and the defect, such as color and representation of brightness. The defect on the printed capsule is usually a dark spot or a black dot. From the perspective of the human eye, the brightness and the hue of the dark spot or dot are different from the capsule itself and the character. Therefore, the image of the printed capsule can be processed in terms of brightness and hue, so as to suppress or eliminate the influence of characters on the defect detection and highlight the defect on the printed capsule.

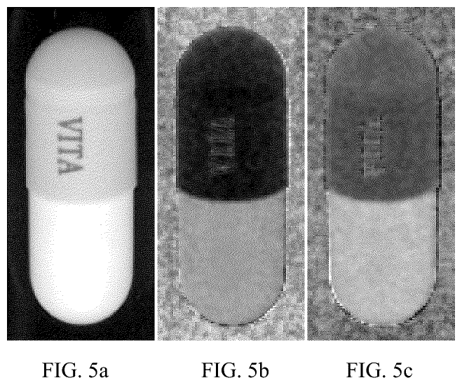

Based on the above detection principles, it is found that the L channel of the Lab color space can simulate the discrimination of brightness by the human eye. There is a huge difference between the appearance of defects such as the dark spot on the printed capsule and the appearance of the capsule itself and the character in terms of brightness. Therefore, the defect detection may be performed based on the image component of the printed capsule in the L channel. It is also considered that the appearance of an image is a collection of values of various dimensions such as brightness, hue and saturation rather than an isolated brightness, and the appearances of the values of different dimensions may affect each other. It is difficult based on the appearance of the value of an isolated dimension to accurately highlight the defect and suppress the influence of characters and the capsule body itself on the defect detection. For example, in the image component of the L channel in FIG. 5a, FIG. 5b and FIG. 5c, there is still a large difference in the appearance of the character and the capsule body, which may have an impact on the defect detection. Therefore, the image component in the brightness dimension is subsidiary processed in combination with the image component in the hue dimension, so that the character in the image of the defective printed capsule has the similar appearance with the capsule body. The similar appearance refers to, for example, that the similarity of intensity component between the character and the capsule body reaches a preset threshold. The intensity component may indicate grayscale. The preset threshold may be greater than 80%, for example.

In order to better eliminate the different representation of the character and the capsule body in the image component in the brightness dimension, that is, the mapping of their different hues representation on brightness, the image component in the brightness dimension is overlying compensated by a channel image component that is different from or even opposite to the image component in the brightness dimension, so that the character is similar to the representation of the capsule body itself in the image obtained after fusion (for example, for the image component of the brightness dimension, if the intensity representation of the character and the capsule body in the intensity appearance is similar to that observed by the human eye, then the image component in the brightness dimension is fused and compensated by a channel image component that highlights the character more, so that the character is similar to the capsule body in appearance).

Taking a red capsule body printed with white characters and with a black spot defects as an example, the inventor converts the image of the printed capsule with defects into different channels of respective color spaces. Because the capsule itself is red with a slight violet tint, the G (green) channel is right complementary to the capsule colour, so its intensity is pure and only highlights the intensity of the character area. In this way, the image component of the G channel and the image component of the L channel are combined to obtain an image of the printed capsule with highlighted defects.

Next, step S120 and step S130 are performed based on the example of the above embodiment. The to-be-processed image is converted into two different color spaces, and the image components of the to-be-processed image in two different channels are obtained.

In step S120, the to-be-processed image is converted to a first color space, and a first image component of the to-be-processed image in a first channel is acquired.

The first channel describes at least hue information of the image. The pattern and the background in the first image component behave differently than in a second image component in terms of intensity.

As described in the above embodiments, the to-be-processed image is obtained based on the original image captured by the image acquisition device. The original image captured by the image acquisition device is usually in a certain format. In the scenario of defect detection on the capsule, the original image captured by the image acquisition device is generally in the YCrCb format. In addition, the format of the enhanced image usually is not different, that is, the to-be-processed image after the enhancement still maintains the same format as the original image. Therefore, in an embodiment, the to-be-processed image in YCrCb format is converted to the first color space, and the first image component of the to-be-processed image in the first channel is acquired. Specifically, the first color space may be an RGB color space. The first image component of the to-be-processed image in the first channel may be an intensity component of the to-be-processed image in the G channel.

It should be understood that the conversion of the image in the YCrCb format to the RGB color space involves the existing technology, and thus is not described in detail herein.

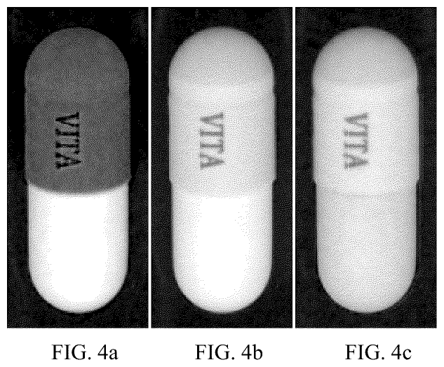

Reference is made to FIG. 4a, FIG. 4b and FIG. 4c, which shows respective intensity components of the three channels of R, G, and B after the to-be-processed image is converted to the RGB color space. FIG. 4a shows the intensity component of the R channel. FIG. 4b shows the intensity component of the G channel. FIG. 4c shows the intensity component of the B channel. It can be seen from FIG. 4a, FIG. 4b and FIG. 4c that the intensity component of the G channel mainly reflects the intensity of the characters printed on the surface of the capsule, while the intensity of other positions (such as the capsule body, which is also called the background) is shielded.

In step S130, the to-be-processed image is converted into a second color space, and a second image component of the to-be-processed image in a second channel is acquired.

The second channel describes at least brightness information of the image. The contrast of the intensity between the pattern and the background in the second image component is similar to a contrast of the intensity between the pattern and the background in the to-be-processed image.

The similar contrast may indicate that the difference in the contrast meets a preset value, for example, the preset value is 10%. The contrast of intensity between the pattern and the background in the second image component is 80%, and in the to-be-processed image is 75%, and therefore it is considered that the contrast of intensity between the pattern and the background in the second image component is similar to that in the to-be-processed image.

In an embodiment, the second color space is a Lab color space, and the second channel is an L channel.

Reference is made to FIG. 5a, FIG. 5b and FIG. 5c, which shows the intensity components of the three channels L, a, and b after the original image is converted into the Lab color space. It can be seen that the intensity components of the three channels highlight the details of the different positions and features on the capsule, respectively. FIG. 5a shows the intensity component of the L-channel. FIG. 5b shows the intensity component of the a-channel. FIG. 5c shows the intensity component of the b-channel. It can be seen from FIG. 5a, FIG. 5b and FIG. 5c that the intensity component of the L-channel presents the intensity appearance of each position of the capsule when the human eye observes the capsule to the greatest extent.

It is considered that the original image or the to-be-processed image may be in the format outputted by the image acquisition device, that is, the YCrCb format. Images in YCrCb format cannot be directly converted to Lab color space. In an example of this embodiment, the converting the to-be-processed image to the second color space includes: converting the to-be-processed image to the first color space to obtain a first image.

Specifically, the first color space may be the RGB color space. Here, the to-be-processed image in YCrCb format may be converted into the RGB color space to obtain the first image.

The first image is converted to the second color space.

After obtaining the first image of the to-be-processed image in the RGB color space, the first image is converted to the Lab color space. The conversion of the image in the RGB color space to the Lab color space involves the existing technology, and thus is not described in detail herein.

In the foregoing embodiments, the RGB color space serves as the first color space and the Lab color space serves as the second color space in order to illustrate how to obtain the image components of the to-be-processed image in two different channels. However, the present application does not limit the details about the first color space, and the first color space is an RGB color space or an XYZ color space.

Specifically, in the case where the second color space is the Lab color space, that is, the second channel is the L channel, the first channel of the first color space may be the R channel of the RGB color space, or the G channel of the RGB color space, or the B channel of the RGB color space, or the X channel of the XYZ color space, or the Y channel of the XYZ color space or the Z channel of the XYZ color space. The specifical first channel of the first color space can be determined according to the actual color of the pattern, and thus is not limited in this embodiment. Those skilled in the art may select the first channel by taking the red capsule as an example.

After the image components of the to-be-processed image in two different channels are obtained, step S140 is performed. That is, image fusion is performed on the first image component and the second image component to obtain a target image.

The pattern is similar to the background in terms of the intensity in the target image.

The pattern being similar to the background in terms of the intensity indicates that, for example, the similarity between intensity components of the pattern and the background reaches a preset threshold. The intensity components may be grayscale values. The preset threshold may be greater than 80%, for example.

In an embodiment, the performing the image fusion on the first image component and the second image component to obtain the target image includes: performing the image fusion on the first image component and the second image component to obtain a candidate target image.

It can be seen from the above embodiments that the intensity components of color channels highlight the details of positions and features on the capsule, respectively. For example, the intensity component of the G color channel mainly reflects the intensity of the characters printed on the surface of the capsule while the intensity of other positions is shielded. The intensity component of the L color channel reflects the intensity appearance of each position when the human eye observes the capsule to the greatest extent. In order to suppress or eliminate the influence of characters printed on the surface of the capsule on the defect detection, fusion is performed on the first image component and the second image component. For example, weighted fusion is performed on these two image components as follows:

I(x,y)=I_{L}(x,y)·α+I_{G}(x,y)·β

Wherein, I(x,y) represents the intensity component outputted after the weighted fusion. I_{L}(x,y) represents the intensity component of the L channel. I_{G}(x,y) represents the intensity component of the G channel. α and β are weight values set as required, for example, both are set to 1.

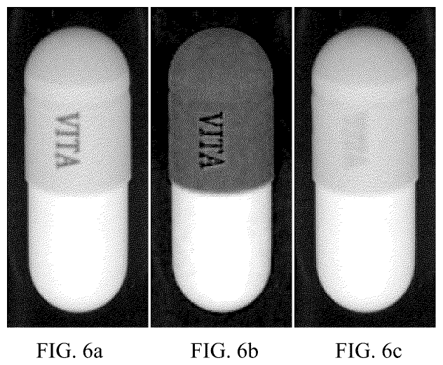

As shown in FIG. 6a, FIG. 6b and FIG. 6c, FIG. 6a shows the intensity component of the L channel, FIG. 6b shows the intensity component of the G channel, and FIG. 6c shows the intensity component after the weighted fusion. It can be seen that in the image obtained from the weighted fusion, the printed characters have been mostly erased, and the printed capsule is almost the same as an ordinary monochrome capsule.

Preset filtering is performed on the candidate target image to obtain the target image.

It can be seen from FIG. 6a, FIG. 6b and FIG. 6c that the characters in the image obtained after the weighted fusion have not been completely erased, and there are some residual high-frequency signals mainly at the edge of the characters. In this case, a low-pass spatial filter may be applied to the input. The low-pass spatial filter is configured to reduce sharp transitions in grayscale and is generally configured to reduce irrelevant details in an image. Here “irrelevant” refers to pixel areas smaller than the filter kernel, or false contours in the image caused by insufficient grayscale. Commonly used low-pass filters include: a mean filter, a Gaussian (Gaussian) filter and a median filter. The median filter is mainly used to eliminate the salt and pepper noise in the image. Compared with the mean filter, the Gaussian filter has a more complicated calculation process and a smoother result. Further, the filter kernel used by the Gaussian filter, i.e., the Gaussian kernel, is circularly symmetric (also known as isotropic, which means response is independent of direction).

The Gaussian kernel is the only separable circularly symmetric kernel. Due to its separability, the Gaussian filter has computational advantages comparable to the mean filter.

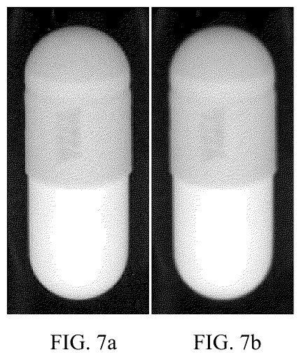

In this embodiment, the image obtained by the weighted fusion is further processed by using the characteristic of the Gaussian filter, so as to weaken the response of the edges of the characters and suppress the noise of the overall image. FIG. 7a and FIG. 7b show the effect after the Gaussian filtering is applied. FIG. 7a shows the weighted image before the Gaussian filtering. FIG. 7b shows the weighted image after the Gaussian filtering. It can be seen that after the Gaussian filtering, the characters printed on the surface of the capsule are further compensated to a grayscale similar to the surrounding.

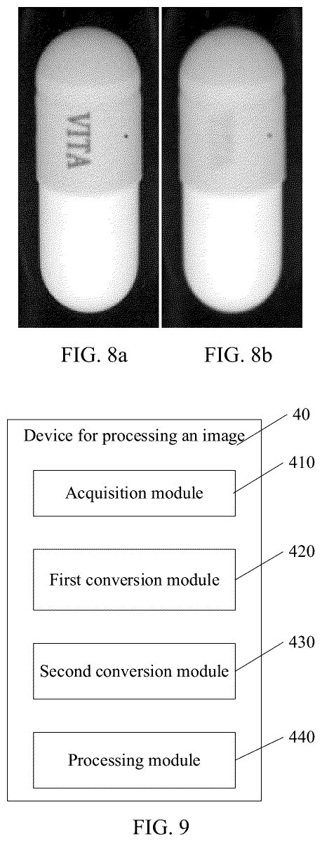

According to the method for processing an image in the above embodiments, the characters printed on the surface of the capsule can be blurred or even erased, so as to perform the defect detection on the capsule. That is, the target image obtained by processing the image of the printed capsule with the method according to the present application is equivalent to or the same as the image of a monochrome capsule. Therefore, the detection for the monochrome capsule is directly applied to perform defect detection on the target image. In order to verify the effect of the target image processed by the present application on defective capsules, and to confirm that the present application can effectively compensate the printed characters without affecting the characteristics of the defects, an experiment was carried out. FIG. 8a and FIG. 8b show examples of a defective capsule with black spots, and FIG. 8a shows the original image of the defective capsule with black spots. It can be seen that the two black dots are located inside the characters and between the characters, respectively. For the defects at these positions, existing detections undoubtedly filter out these defects, resulting in missed detection of defective products.

FIG. 8b shows the target image after the original image of the capsule with black spots is processed by the present application. It can be seen that while the characters are compensated, the black dot defects are well preserved.

With the method for processing an image according to embodiments of the present application, the to-be-processed image including the background and the pattern is converted to the first color space and the second color space to acquire the first image component of the to-be-processed image in the first channel and the second image component of the to-be-processed image in the second channel, respectively. The first channel describes at least hue information of the image. The second channel describes at least brightness information of the image. The pattern and the background in the first image component behave differently than in a second image component in terms of intensity. The contrast of the intensity between the pattern and the background in the second image component is similar to a contrast of the intensity between the pattern and the background in the to-be-processed image. Finally, image fusion is performed on the first image component and the second image component to obtain the target image. The pattern is similar to the background in terms of the intensity in the target image. Image components of two different channels of the to-be-processed image in two respective color spaces that meet preset conditions are acquired, and then the two image components are fused in the preset manner, so that the difference between the pattern and the background in the to-be-processed image is reduced, thereby significantly reducing the influence of the pattern on the subsequent defect detection, and bringing a better experience to the user. In addition, because the processing only involves simple conversion between color spaces and simple calculation, the complexity is lower and the efficiency is higher, which can quickly and efficiently reduce the difference between the pattern on the capsule body in the image and the capsule body, and thus is more suitable for capsule appearance detection in real-time.

Illustrative Device

After introducing the method according to the embodiments of the present application, a device for processing an image according to an embodiment of the present application is described next with reference to FIG. 9. The device 40 includes an acquisition module 410, a first conversion module 420, a second conversion module 430 and a processing module 440.

The acquisition module 410 is configured to acquire a to-be-processed image. The to-be-processed image includes at least a background and a pattern.

The first conversion module 420 is configured to convert the to-be-processed image into a first color space, to obtain a first image component of the to-be-processed image in a first channel. The first channel describes at least hue information of the image. The pattern and the background in the first image component behave differently than in a second image component in terms of intensity.

The second conversion module 430 is configured to convert the to-be-processed image into a second color space, to obtain a second image component of the to-be-processed image in a second channel. The second channel describes at least brightness information of the image. A contrast of the intensity between the pattern and the background in the second image component is similar to a contrast of the intensity between the pattern and the background in the to-be-processed image.

The processing module 440 is configured to perform image fusion on the first image component and the second image component to obtain a target image. The pattern is similar to the background in terms of the intensity in the target image.

In an embodiment, the acquisition module 410 is further configured to acquire an original image, and perform enhancement processing on the original image to obtain the to-be-processed image.

In an embodiment, the processing module 440 is further configured to perform image fusion on the first image component and the second image component to obtain a candidate target image; and perform preset filtering processing on the candidate target image to obtain the target image.

In an embodiment, the second conversion module 420 is further configured to convert the to-be-processed image into the first color space to obtain a first image; and convert the first image into the second color space to obtain the second image component of the to-be-processed image in a second channel.

In an embodiment, the first color space is an RGB color space or an XYZ color space, and the second color space is a Lab color space.

In an embodiment, the first channel is a G channel when the first color space is the RGB color space, and the second channel is an L channel when the second color space is the Lab color space.

In an embodiment, the original image is an image of a package, the background is a package body, and the pattern includes at least one of a character, a logo and a graphic.

With the device for processing an image according to the embodiments of the present application, the to-be-processed image including the background and the pattern is converted to the first color space and the second color space to acquire the first image component of the to-be-processed image in the first channel and the second image component of the to-be-processed image in the second channel, respectively. The first channel describes at least hue information of the image. The second channel describes at least brightness information of the image. The pattern and the background in the first image component behave differently than in a second image component in terms of intensity. The contrast of the intensity between the pattern and the background in the second image component is similar to a contrast of the intensity between the pattern and the background in the to-be-processed image. Finally, image fusion is performed on the first image component and the second image component to obtain the target image. The pattern is similar to the background in terms of the intensity in the target image. Image components of two different channels of the to-be-processed image in two respective color spaces that meet preset conditions are acquired, and then the two image components are fused in the preset manner, so that the difference between the pattern and the background in the to-be-processed image is reduced, thereby significantly reducing the influence of the pattern on the subsequent defect detection, and bringing a better experience to the user. In addition, because the processing only involves simple conversion between color spaces and simple calculation, the complexity is lower and the efficiency is higher, which can quickly and efficiently reduce the difference between the pattern on the capsule body in the image and the capsule body, and thus is more suitable for capsule appearance detection in real-time.

Illustrative Medium

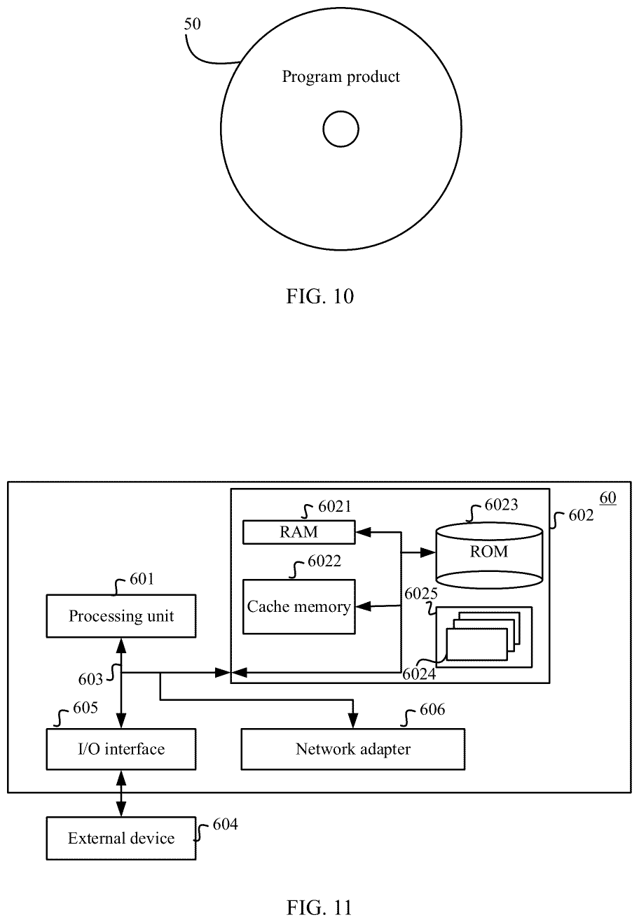

After introducing the method and the device according to the embodiments of the present application, a computer-readable storage medium according to an embodiment of the present application is described below with reference to FIG. 10. The computer-readable storage medium shown in FIG. 10 is an optical disc 50 on which a computer program (i.e., a program product) is stored. The computer program, when run by a processor, implements the steps described in the method embodiments, for example, acquiring a to-be-processed image, where the to-be-processed image includes at least a background and a pattern; converting the to-be-processed image into a first color space to obtain a first image component of the to-be-processed image in a first channel, where the first channel describes at least hue information of the image, and the pattern and the background in the first image component behave differently than in a second image component in terms of intensity; converting the to-be-processed image into a second color space to obtain a second image component of the to-be-processed image in a second channel, where the second channel describes at least brightness information of the image, and a contrast of the intensity between the pattern and the background in the second image component is similar to a contrast of the intensity between the pattern and the background in the to-be-processed image; and performing image fusion on the first image component and the second image component to obtain a target image, where the pattern is similar to the background in terms of the intensity in the target image. Details about the steps are not repeated here.

It should be noted that examples of the computer-readable storage medium may also include but not limited to a phase change memory (PRAM), a static random access memory (SRAM), a dynamic random access memory (DRAM), a random access memory (RAM) of other type, a read-only memory (ROM), an electrically erasable programmable read-only memory (EEPROM), a flash memory or other optical and magnetic storage media, which are not listed here.

Illustrative Computing Device

After introducing the method, the device and the medium according to the embodiments of the present application, the computing device for processing an image according to an embodiment of the present application is described next with reference to FIG. 11.

FIG. 11 shows a block diagram of a computing device 60 for implementing the embodiments of the present application. The computing device 60 may be a computer system or a server. The computing device 60 shown in FIG. 11 is only an example, and should not limit the functions and scope of use of the embodiments of the present application.

As shown in FIG. 11, the components of the computing device 60 may include, but are not limited to: one or more processors or processing units 601, a system memory 602, and a bus 603 connecting system components (including the system memory 602 and the processing unit 601).

The computing device 60 typically includes a variety of computer system readable media. These media may be any available media that is accessible to the computing device 60 and include volatile and nonvolatile media, as well as removable and non-removable media.

The system memory 602 may include computer system readable media in the form of volatile memory, such as a random-access memory (RAM) 6021 and/or a cache memory 6022. The computing device 60 may further include other removable/non-removable, volatile/nonvolatile computer system storage media. By way of example only, a ROM 6023 may read data from and write data to a non-removable, non-volatile magnetic medium (not shown in FIG. 11 and commonly referred to as a “hard drive”). Although not shown in FIG. 11, a disk drive for reading data from and writing data to removable non-volatile disks (such as “floppy disks”), as well as an optical drive for reading data from and writing data to removable non-volatile optical discs (such as CD-ROMs, DVD-ROMs or other optical media) may be provided. In these cases, each drive may be connected to the bus 603 via one or more data media interfaces. At least one program product may be included in the system memory 602. The program product has a set (e.g., at least one) of program modules. These program modules are configured to perform the functions of the various embodiments of the present application.

A program/utility 6025 having a set of (at least one) program modules 6024 may be stored in the system memory 602, for example. Such program modules 6024 include, but are not limited to, an operating system, one or more application programs, other program modules, and program data. Implementations of networked environments may be included in each or some combination of these examples. The program modules 6024 generally perform the functions and/or methods of the described embodiments of the present application.

The computing device 60 may also communicate with one or more external devices 604 (e.g., a keyboard, a pointing device and a display). Such communication may occur through an input/output (I/O) interface 605. Moreover, the computing device 60 also communicates with one or more networks (e.g., a local area network (LAN), a wide area network (WAN) and/or a public network, e.g., the Internet) through a network adapter 606. As shown in FIG. 11, the network adapter 606 communicates with other modules of the computing device 60 (such as the processing unit 601) through the bus 603. It should be appreciated that although not shown in FIG. 11, other hardware and/or software modules may be used in conjunction with the computing device 60.

The processing unit 601 executes various functional applications and data processing by running the programs stored in the system memory 602, for example, acquiring a to-be-processed image, where the to-be-processed image includes at least a background and a pattern; converting the to-be-processed image into a first color space to obtain a first image component of the to-be-processed image in a first channel, where the first channel describes at least hue information of the image, and the pattern and the background in the first image component behave differently than in a second image component in terms of intensity; converting the to-be-processed image into a second color space to obtain a second image component of the to-be-processed image in a second channel, where the second channel describes at least brightness information of the image, and the a contrast of the intensity between the pattern and the background in the second image component is similar to a contrast of the intensity between the pattern and the background in the to-be-processed image; and performing image fusion on the first image component and the second image component to obtain a target image, where the pattern is similar to the background in terms of the intensity in the target image. Details about the steps are not repeated here.

It should be noted that although several units/modules or subunits/submodules of the device for processing an image are mentioned in the above detailed description, this division is only exemplary rather than mandatory. Actually, according to the embodiment of the present application, the features and functions of two or more units/modules described above may be embodied in one unit/module. Alternatively, the features and functions of one unit/module described above may be further divided so as to be embodied by multiple units/modules.

In addition, although operations of the method of the present application are shown in the drawings in a particular order, there is no requirement or implication that these operations must be performed in that particular order, or that all illustrated operations must be performed in order to achieve desirable results. Additionally or alternatively, some steps may not be performed, multiple steps may be combined into one step for performing, and/or one step may be divided into multiple steps for performing.

Although the spirit and principles of the present application have been described with reference to several typical embodiments, it should be understood that the present application is not limited to the embodiments disclosed. The division of aspects does not mean that features in these aspects cannot be combined to benefit, and this division is only for the convenience of expression. The present application is intended to cover various modifications and equivalent arrangements included within the spirit and scope of the appended claims.

What is claimed is:

1. A method for processing an image, comprising:
acquiring a to-be-processed image, wherein the to-be-processed image at least comprises a background and a pattern;
converting the to-be-processed image into a first color space to obtain a first image component of the to-be-processed image in a first channel, wherein the first channel describes at least hue information of the image, and the pattern and the background in the first image component behave differently than in a second image component in terms of intensity;
converting the to-be-processed image into a second color space to obtain the second image component of the to-be-processed image in a second channel, wherein the second channel describes at least brightness information of the image, and a contrast of the intensity between the pattern and the background in the second image component is similar to a contrast of the intensity between the pattern and the background in the to-be-processed image; and
performing image fusion based on the first image component and the second image component to obtain a target image, wherein the pattern is similar to the background in terms of the intensity in the target image, the target image is used for detecting appearance defect of a package on which the pattern is printed;
wherein the first channel is a G channel in a case that the first color space is a Red-Green-Blue (RGB) color space, and the second channel is an L channel in a case that the second color space is a Lab color space.

2. The method for processing an image according to claim 1, wherein the acquiring a to-be-processed image comprises:
acquiring an original image, and performing enhancement processing on the original image to obtain the to-be-processed image.

3. The method for processing an image according to claim 1, wherein the performing image fusion based on the first image component and the second image component to obtain a target image comprises:
performing the image fusion based on the first image component and the second image component to obtain a candidate target image; and
performing preset filtering processing on the candidate target image to obtain the target image.

4. The method for processing an image according to claim 1, wherein the converting the to-be-processed image into a second color space comprises:
converting the to-be-processed image into the first color space to obtain a first image; and
converting the first image into the second color space.

5. The method for processing an image according to claim 1, wherein the first color space is the RGB color space or an XYZ color space, and the second color space is a Lab color space.

6. The method for processing an image according to claim 2, wherein the original image is an image of a package, the background is a package body, and the pattern comprises at least one of a character, a logo and a graphic.

7. A device for processing an image, comprising:
an acquisition module configured to acquire a to-be-processed image, wherein the to-be-processed image at least comprises a background and a pattern;
a first conversion module configured to convert the to-be-processed image into a first color space to obtain a first image component of the to-be-processed image in a first channel, wherein the first channel describes at least hue information of the image, and the pattern and the background in the first image component behave differently than in a second image component in terms of intensity;
a second conversion module configured to convert the to-be-processed image into a second color space to obtain the second image component of the to-be-processed image in a second channel, wherein the second channel describes at least brightness information of the image, and a contrast of the intensity between the pattern and the background in the second image component is similar to a contrast of the intensity between the pattern and the background in the to-be-processed image; and
a processing module configured to acquire perform image fusion based on the first image component and the second image component to obtain a target image, wherein the pattern is similar to the background in terms of the intensity in the target image, the target image is used for detecting appearance defect of a package on which the pattern is printed,
wherein the first channel is a G channel in a case that the first color space is an RGB color space, and the second channel is an L channel in a case that the second color space is a Lab color space.

8. A non-transitory computer-readable storage medium storing a program, wherein when the program is executed by a processor, the method according to claim 1 is implemented.

9. A computing device, comprising:
a processor; and
a storage medium storing a program, wherein when the program is executed by the processor, the method according to claim 1 is implemented.
